(19) United States
(12) Patent Application Publication
(10) Pub. No.: US 2007/0273939 A1
(43) Pub. Date: Nov. 29, 2007

(54) Image pick-up apparatus for microscopes

(76) Inventors: Hironori Kishida, Tokyo-to (JP); Shinichiro Aizaki, Tokyo-to (JP)

Correspondence Address: KENYON & KENYON LLP, ONE BROADWAY, NEW YORK, NY, 10004, US

(21) Appl. No.: 11/805,396

(22) Filed: May 22, 2007

(30) Foreign Application Priority Data
May 24, 2006 (JP) 2006-144439

(51) Int. Cl. H04N 1/46

(52) U.S. Cl. 358/504

(57) ABSTRACT

The image pick-up apparatus for microscopes according to the present invention is constituted such that an image pick-up apparatus is used as a calibration tool, and a predetermined image-for-calibration displayed on a display screen of a desired display apparatus is photographed. By referring to chromaticity information-for-calibration obtained by photographing mentioned above and chromaticity information of a display part itself, adjustment of color comparison can be carried out much simply.

This application claims benefits of Japanese Patent Application No. 2006-144439 filed in Japan on May 24, 2006, the contents of which is hereby incorporated by reference.

### BACKGROUND OF THE INVENTION

1. Field of the Invention

The present invention relates to an image pick-up apparatus for microscopes having function for correction of display of an image-picked-up in a microscope system provided with a digital camera.

2. Description of the Related Art

Conventionally, in order to record an observed image of a sample under a microscope, the observed image is photographed and recorded by a film camera attached to a portion of an eyepiece. However, recently, with development of performance of a digital camera (an electronic still camera and a digital video camera), from the viewpoint of an advantage such that a recorded picture can be looked by a monitor on the spot immediately after photographing, a method of photographing and recording an observed image using a digital camera has been used.

As a monitor for displaying a photographed observed image, various types of apparatuses have been offered. Such apparatuses includes a monitor incorporated beforehand as a monitor which is exclusively used for displaying a photographed image in a photographing apparatus, and a monitor in which a photographed image data is stored in a personal computer (PC) etc., and an observed image can be seen by connecting arbitrarily to a monitor according to a user's observation environment.

As these monitors, in place of CRT represented by a conventional cathode-ray tube, a liquid crystal display monitor in which space-saving and power-saving are possible is spreading widely. However, in the liquid crystal display monitor, an individual specificity owing to variation in a color filter etc., is large. Therefore, in particular, when an observed-image-by-microscope having more specific color components (red, green) is displayed, difference owing to the individual specificity becomes conspicuous. Especially, when a monitor is changed accompanying with change of PC model, in spite of displaying an image of the same specimen, a problem such that color different from that displayed before is displayed has occurred.

Conventionally, as a method for correcting characteristics of a monitor, for example, in Publication of the Japanese unexamined patent application, Toku Kai No. 2002-135790, an apparatus has been proposed, wherein a photographic subject for calibration is photographed by an image pick-up apparatus itself, and comparison of color is carried out by comparing data of the photographed image and an image-for-calibration which becomes an expected value, and calculating a value of correction. Moreover, in Publication of the Japanese unexamined patent application, Toku Kai No. 2004-120540, a method wherein generation of an image-for-calibration, photographing and correction of a color chart, etc., are carried out in one device has been proposed.

For example, in an apparatus shown in Publication of the Japanese unexamined patent application, Toku Kai No. 2002-135790,image data D1 which was picked-up by an electronic camera is displayed on a display means, and image data D2 re-picked-up in which a regenerated and displayed image is picked-up again by the camera originally used before, is obtained. Then, a value of correction of an image for overalls including the image pick-up system and the display system is calculated by comparing D1 with D2, and this correction is applied to D1 and this is recorded as D3.

An apparatus shown in Publication of the Japanese unexamined patent application, Toku Kai No. 2004-120540, is constituted such that in an image apparatus having image pick-up function and display function, it has a predetermined image-for-calibration, wherein correction to the image pick-up system is carried out so that an image for object may be displayed correctly on the basis of a result of having photographed the image-for-calibration by using the image pick-up function.

### SUMMARY OF THE INVENTION

The image pick-up apparatus for microscopes according to the present invention comprises a display means which displays an image, an image-for-calibration-generation-means to generate a predetermined image-for-calibration which is displayed on the display means, and an image pick-up means for photographing the image-for-calibration displayed on a display screen of the display means, and is characterised in that standard color information as a criterion of color of the image-for-calibration which is generated by the image-for-calibration-generation-means, and color information in the image-for-calibration which has been photographed by the image pick-up means, are displayed on the display screen of the display means.

The image pick-up apparatus for microscopes according to the present invention comprises an operation-process-control-means which corrects a displayed color by the display means in which the color information in the image-for-calibration photographed by the image pick-up means, and standard color information of the image-for-calibration which is generated by the image-for-calibration-generation-means are displayed on coordinates of color coordinates displayed on the display means, and a displayed color by the display means is corrected so that the standard color information of the image-for-calibration which is generated by the image-for calibration-generation-means, and the color information in the image-for-calibration photographed by the image pick-up means may be coincided.

The image pick-up apparatus for microscopes according to the present invention comprises a color-correction-means arranged at the display means, in which color correction which changes color correction condition to an image displayed on a display screen, and an operation-process means which corrects a displayed color by the display means in which color information of the image-for-calibration photographed by the image pick-up means, and standard color information of the image-for-calibration generated by the image-for-calibration-generation-means are displayed on coordinates of color coordinates displayed on the display means, and the displayed image by the display means is corrected so that the standard color information of the image-for-calibration generated by the image-for-calibration generation means and the color information of the image-for-calibration photographed by the image pick-up means may be coincided, wherein when a coincidence process of the standard color information of the image-for-calibration and the color information of the image-for-calibration by the color-correction-means exceeds a color correction range of the color-correction-means, the coincidence process by an operation-process-control-means is performed.

The image pick-up apparatus for microscopes according to the present invention, comprises an image pick-up means, a recording means to record an image picked up, a display means which displays the image, an image-for-calibration-generation-means in which the characteristics value of the image in the image generates a known image-for-calibration, and a control means in which the image-for-calibration of the image-for-calibration-generation-means is displayed on the display means, and data of the image-for-calibration picked up by the image pick-up means is recorded, and the characteristics value of the image of a recorded data of the image-for-calibration is analyzed, and then the analyzed characteristics value of the image and the characteristics value of the image-for-calibration are displayed on the display means.

An image adjustment method of the image pick-up apparatus for microscopes according to the present invention is an image adjustment method which can be applied to an image pick-up apparatus for microscopes. It comprises an image pick-up means, a recording means to record an image picked up, a display means to display the image, and an image-for-calibration-generation-means in which the characteristics value of the image in the image generates a known image-for-calibration, and it is characterised in that the image-for-calibration is outputted from the image-for-calibration-generation-means, and the image-for-calibration is displayed on the display means, and the image-for-calibration displayed on the display means is picked up by the image pick-up means, and data of the image-for- calibration picked up by the image pick-up means is recorded, and the characteristics value of the image of a recorded data of the image-for-calibration is analyzed, and the analyzed characteristics value of the image and the characteristics value of the image-for-calibration are displayed on the display means.

According to the present invention, an image pick-up apparatus for microscopes in which calibration work of an image display apparatus for microscopes by an operator can be assisted, and appropriate correction is always possible can be offered.

According to the image pick-up apparatus for microscopes of the present invention, the operator can carry out much simpler calibration of color of a display screen, while checking an appropriate condition of operation for adjustment of image screen setting since the image pick-up apparatus itself is used as a calibration tool for a display apparatus for observed images, without using any special jig and tool as used conventionally, and an image-for-calibration used as standard, and each state of color distribution in the image picked-up in which the said image-for-calibration has been photographed.

According to the image pick-up apparatus for microscopes of the present invention, even if sufficient adjustment function in the display apparatus is not arranged, the operator can carry out calibration on a display screen since it is possible to carry out image process for color correction in the image pick-up apparatus. Furthermore, since the quality of a state of arrangement of the image pick-up apparatus can be judged beforehand when a calibration work is carried out, failure of calibration can be prevented. Moreover, since color for correction can be changed according to the color distribution of a specimen, calibration of color can be much appropriately carried out by the specimen.

These and other features and advantages of the present invention will become apparent from the following detailed description of the preferred embodiments when taken in conjunction with the accompanying drawings.

### BRIEF DESCRIPTION OF THE DRAWINGS

FIG. 1 is a diagram showing an outlined constitution of an image pick-up apparatus for microscopes concerning a first embodiment according to the present invention.

FIG. 2 is a diagram showing an outlined constitution of an image pick-up part concerning the first embodiment according to the present invention.

FIG. 3 is a diagram showing an outlined constitution of an image process part concerning the first embodiment according to the present invention.

FIG. 4 is a diagram showing an outline of an input-and-output signal of a gradation-level-correction-part in the first embodiment.

FIG. 5 is a diagram showing an outlined constitution of a correction-control-part concerning the first embodiment according to the present invention.

FIG. 6 is a flow chart for explaining a process procedure of the first embodiment.

FIG. 7 is a diagram showing a side view of an arrangement of an image pick-up apparatus and a display apparatus concerning the first embodiment according to the present invention.

FIG. 8 is a diagram showing a front view of an arrangement of the image pick-up apparatus and the display apparatus concerning the first embodiment according to the present invention.

FIG. 9 is a chromaticity diagram displayed on the display apparatus in the first embodiment.

FIG. 10 is a chromaticity diagram displayed on the display apparatus in the first embodiment.

FIG. 11 is a diagram showing a brightness value of an image generated by an image-for-calibration-generation-part in a modification of the first embodiment.

FIG. 12 is a diagram showing an outlined constitution of the correction-control-part concerning a second embodiment according to the present invention.

FIG. 13 is a flow chart for explaining the process procedure of the second embodiment.

FIG. 14 is a flow chart for explaining the process procedure of a third embodiment.

FIG. 15 is a flow chart for explaining the process procedure of a fourth embodiment.

FIG. 16 is a diagram showing color-distribution generated in the fourth embodiment.

### DETAILED DESCRIPTION OF THE PREFERRED EMBODIMENTS

Hereafter, with reference to drawings, the embodiments of the present invention will be explained in detail.

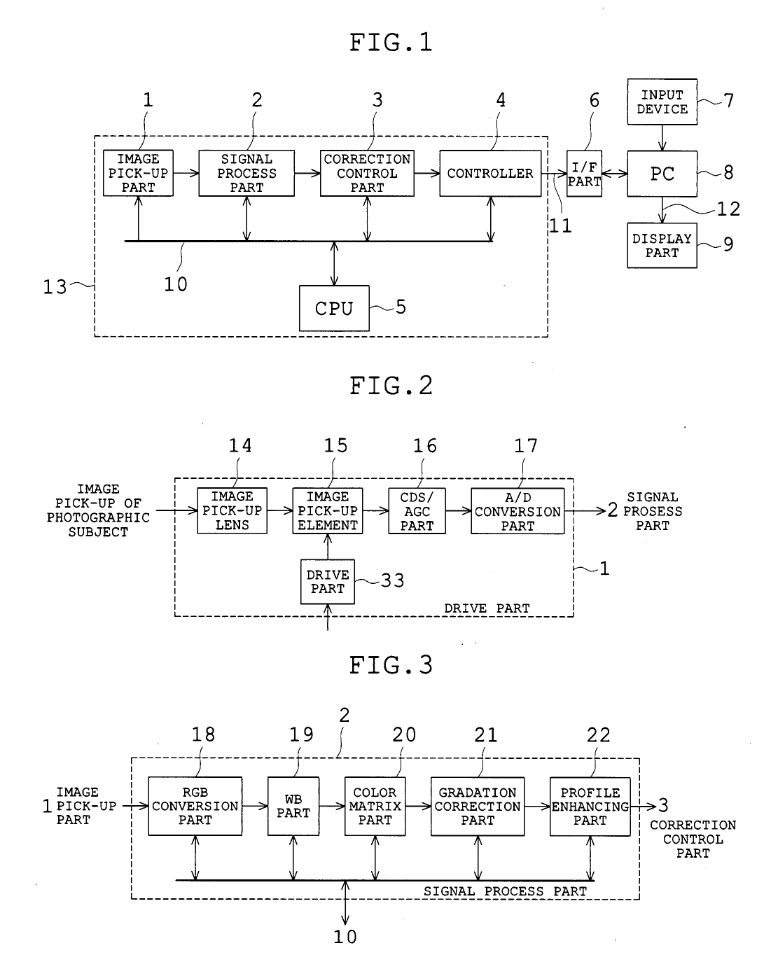

FIG. 1 is a diagram showing an outlined constitution of an image pick-up apparatus for microscopes concerning the first embodiment according to the present invention. This image pick-up apparatus for microscopes is constituted so that it may be connected to a microscope by which observation is carried out using a various observation methods, for example, penetration type bright-field observation or fluorescence observation, via mounting devices, etc. A photographic subject image which is formed by an optical system of the microscope enters into an image pick-up part 1. FIG. 2 shows a constitution of the image pick-up part 1, where the photographic subject image entered is formed on the image pick-up element 15 by an image pick-up lens 14. In the present embodiment, explanation will be made on an image pick-up element, a filter of which is Bayer array, for example.

A drive part 33 is connected with the image pick-up element 15 and a control bus 10, and a driving signal of the image pick-up element 15 is generated under conditions directed from the control part (CPU) 5, and is outputted on the image pick-up element 15. The image pick-up element 15 carries out photoelectric conversion of incidence light according to this driving signal. To a signal (image signal) which was photo-electrically converted in the image pick-up element 15, correlation double sampling (CDS) process and automatic gain control (AGC) process are carried out firstly by CDSGC circuit 16. After these processes, it is converted to the Bayer data of digital signal by A-D converter 17, and is outputted to the signal process part 2 with a synchronized signal which shows a frame and line cycle timing.

As shown in FIG. 3, the signal process part 2 consists of a RGB conversion part 18, a white balance (WB) compensation part 19, a color matrix part 20, a gradation correction part 21, and a profile enhancing part 22, which are connected to the control bus 10, respectively. According to an instruction from the CPU 5 connected through this control bus 10, various image processes are performed to an input image data.

The image data obtained by the image pick-up part 1 is firstly made simultaneously to RGB data from the Bayer data through the RGB conversion part 18, and is outputted to the white-balance-correction-part 19. By multiplying each of color data by a coefficient set up from the CPU 5, the white-balance-correction-part 19 corrects white balance, and outputs it to the color matrix part 20 arranged at the next position.

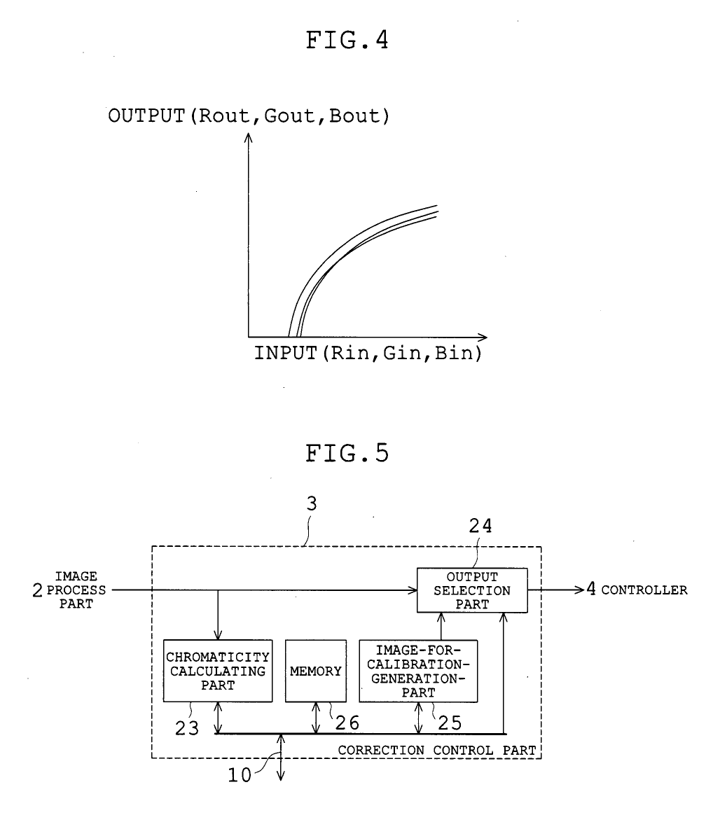

Next, in the color matrix part 20, to the input image data, color reproduction of the image pick-up element is corrected, and it is outputted to the gradation correction part 21 arranged at a later part by a matrix operation of 3×3 to each color of RGB. Gradation correction of the image data inputted into the gradation correction part 21 is carried out through LUT which has input-and-output characteristics as to each color shows in FIG. 4. Then, the image data to which gradation correction was carried out is outputted to the profile enhancing part 22. A profile enhancing part of 22 has a band pass filter, by feeding back and adding a high frequency component of the image data extracted by the band pass filter to the image data inputted. The image data of the profile emphasized is outputted to the correction control part 3.

FIG. 5 shows a constitution of the correction control part 3, which comprises a chromaticity calculating part 23 for extracting color information, an output selection part 24, a correction-image-generation part 25 that generates an image for correction, and a memory 26. These are connected to the control bus 10, respectively. The color information in the present embodiment is information by which difference in the color of an image of standard constitution and an image which photographed it can be identified quantitatively, and for example, it is equivalent to chromaticity difference by a chromaticity diagram, difference of color components, etc. The chromaticity calculating part 23 carries out integration for one frame to the image data inputted from the signal process part 2, and then, obtains chromaticity (X, Y, Z) of average brightness value calculated, or chromaticity of the image data transmitted from CPU 5 via the control bus 10 by a matrix operation, and then the value is stored in a memory 26 via the control bus 10. The memory 26 is connected to the control bus 10, and the CPU 5 reads and writes data in memory 26 through the control bus 10.

The output selection part 24, responding to the order from the CPU 5, selects either of image data inputted from the profile enhancing part 22 of the signal process part 2, or image data from the correction-image-generation-part 25, and outputs it to a controller 4. The correction-image-generation-part 25 outputs image data which has a predetermined RGB value to the chromaticity calculating part 23 according to the order from the CPU 5. The controller 4 is connected to the PC (operation process control part) 8 via the I/F part 6 and the CPU 5 through the control bus 10, and carries out transceiver timing adjustment of the image-pick-up-order data between the PC 8 and the CPU 5 while converting a data format. Furthermore, the controller 4 is connected to the output selection part 24 in the correction control part 3, and transmits the image data inputted from the output selection part 24 to the I/F part 6. The controller 4 and the I/F part 6 are connected by the I/F cable 11, for example. The I/F part 6 having a buffer memory inside, memorizes the data transmitted temporarily, and carries out timing adjustment of data communication between a personal computer (hereafter, it is called as PC) 8 and the controller 4.

The display part 9 and the input device 7 are connected to the PC 8, which is connected to the display part 9 by a monitor cable 12. The display part 9 consists of a LCD monitor such as (TFT) for example, and according to an input signal from the PC 8, an image picked-up, and GUI, letters, etc., which are necessary for an operator to carry out various operations are displayed on the display screen. An input apparatus 7 is an input device such as a button switch, a keyboard, and a mouse by which the operator may give directions of image pick-up conditions, start or end of image picking-up operation, etc. A matter of course, a touch-panel function may be equipped in the LCD monitor for using it as an input device.

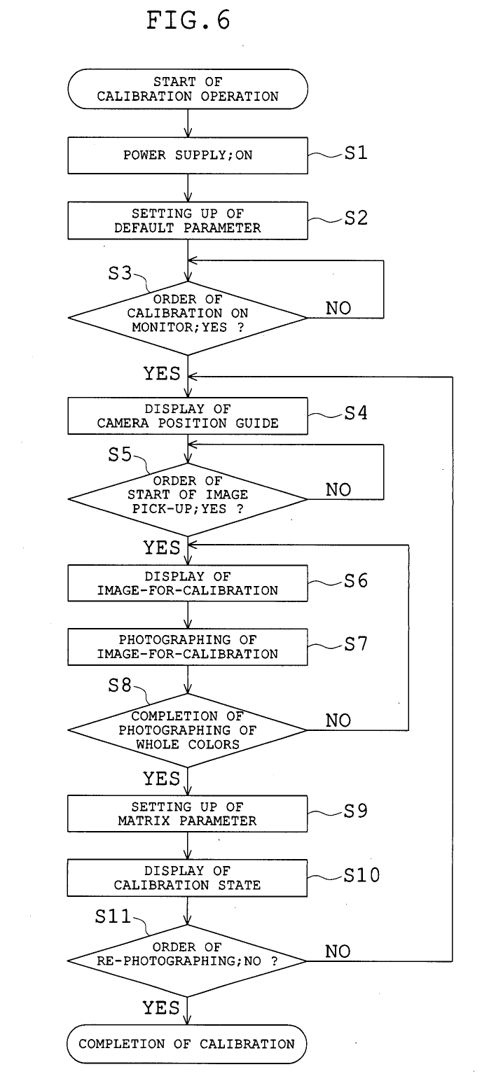

According to the flow chart shown in FIG. 6, operation of the image pick-up apparatus for microscopes constituted as mentioned above will be explained.

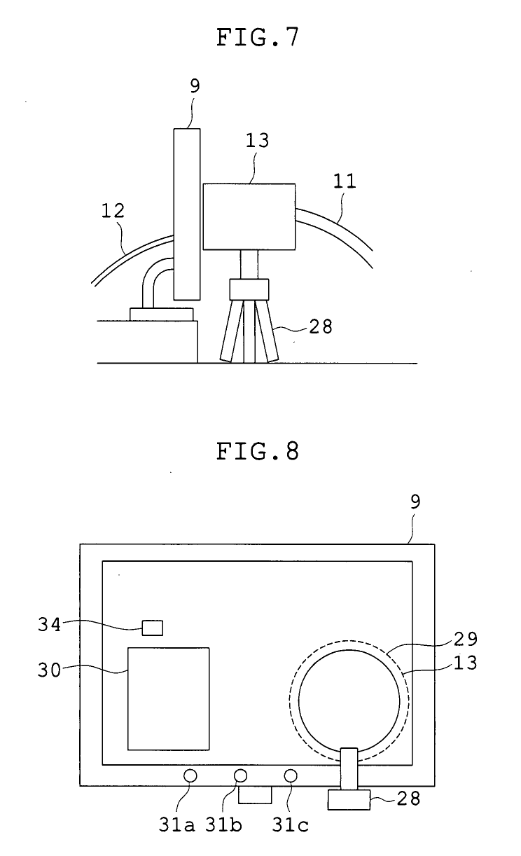

First, as shown in FIG. 7, the operator adjusts using a tripod 28 and the like so that an optical axis of an image pick-up lens 14 of the image pick-up part 1 may become perpendicular to the display screen on a plane of the display part 9 where a main body of a camera 13 of the image pick-up apparatus for microscopes is mounted on a test rack. That is, the display screen and a light receiving surface of the image pick-up element of the image pick-up part 1 may become parallel. After such setting as mentioned above, a power supply of the image pick-up apparatus for microscopes is switched on by the operator (Step S1). After setting up an initial state by the power supply, the PC 8 transmits default data of parameters for image process to the CPU 5 through the I/F part 6 and the controller 4. The default parameter of each image process is set up when the CPU 5 transmits input data to the signal process part 2 (Step S2).

Next, judgment is made as to whether a calibration-operation starts or not (Step S3). A message and a button (icon) for confirming start of calibration-operation are displayed on the display part 9 by the PC, and the operator carries out selection operation. When the operator gives an order of start by clicking this button using the input device 7, the PC 8 performs such that it has received an order of calibration (YES), and as shown in FIG. 8, a guide domain 29 for adjusting an image pick-up position is displayed on a monitor (Step S4). When an order of the start by the button is not made (NO) it stands by until the order is made.

Next, the operator adjusts the position of the main body of the camera 13 so that an image pick-up scope (angle of view) may be coincided with the guide domain 29 of the display screen, and arranges it so that the optical axis of the image pick-up lens 14 and the display surface of the monitor may intersect perpendicularly. After this arrangement, judgment is made as to whether a start button (icon) 34 for picking up the image-for-calibration (that is a button for start of picking-up of an image-for-calibration) currently displayed on the display screen has been directed from the input device 7 or not (Step S5). In this judgment, when the start button 34 for picking up the image-for-calibration is directed, (YES), the PC 8 transmits an order for picking up the image-for-calibration to the CPU 5 through the I/F part 6.On the other hand, in case that the start button icon 34 for start of picking up of the image-for-calibration is not shown (NO), it stands by until it is shown.

In this calibration, a predetermined sample color images are displayed on the display screen of the display part 9 one by one, and these are picked up by the image pick-up part 1 and recorded. Then, on the basis of a result of record mentioned above, sample image data for judging the propriety of the color reproduction performance of the display part 9 is displayed on the display part 9. In concrete display adjustment, setup of the monitor setting buttons 31a, 31b, and 31c for the adjustment arranged at the display part 9 or, a parameter of the video card adapter incorporated with a PC Card slot is carried out.

Concretely, when the CPU 5 receives an order for picking up of an image-for-calibration by judgment of the start button (icon) 34 for picking up the image-for-calibration mentioned above, an order is transmitted to the image-for-calibration-generation-part 25, and color information, for example, an image data which has RGB value (for example, white (R, G, B)=(255, 255, 255)) is made to be outputted to the output selection part 24. Of course, the RGB value is an example, and it is not limited to it. The output selection part 24 transmits this image data to the PC 8 from the controller 4. The chromaticity calculating part 23 computes the chromaticity value (X0, Y0) corresponding to the RGB value which is generated by the image-for-calibration-image-generation-part 25 according to the order from the CPU 5, and it is memorized in the memory 26. At this time, the PC 8 displays the image data from the main part of the camera 13 on the guide domain 29 as it is (Step S6).

After displaying in such way as mentioned above, the order for picking-up of an image is transmitted to the CPU 5, the CPU 5 which received the order from the PC 8 drives the image pick-up element 15 by the drive part 33, and it converts photo-electrically the incidence light from the image pick-up lens 14, and carries out photographing of sample (Step S7). To an image-signal generated as an analog signal by the photoelectric conversion, a predetermined image process is carried out by a CDS/AGC circuit 16, and furthermore, digitization process is carried out by an A-D converter 17. Image data as processed is outputted to the chromaticity calculating part 23 of the correction control part 3 through the signal process part 2. At this time, by a matrix operation which is not illustrated, the chromaticity calculating part 23 computes the chromaticity value (X1, Y1) used as a color information, and stores it in the memory 26.

Next, when the CPU 5 transmits an order to the correction control part 3, the image-for-calibration-generation-part 25 transmits image data of a predetermined RGB value (for example, red (R, G, B)=(255, 0, 0)) which is different from that mentioned above to the output selection part 24. Hereafter, an image-for-calibration such as white, red, blue, green, etc. set up beforehand is displayed on the display part 9, and it is photographed by the image pick-up part 1, and then a chromaticity value is computed. The CPU 5 judges whether photographing has been completed or not after calculation of the chromaticity value (Step S8). If by this judgment, it is judged such that as to whole images-for-calibration set up beforehand, photographing has been carried out (YES), each image-for-calibration memorized in the memory 26, and chromaticity values (X0, Y0) and (X1, Y1) of its image picked up are transmitted to the PC 8. On the other hand, if photographing of whole images-for-calibration is not completed, it returns to Step S6 (NO). Henceforth, when photographing is carried out after displaying an image-for-calibration which has not yet been photographed on the guide domain 29 of the PC 8, the chromaticity calculating part 23 computes a chromaticity value from an image data obtained, and it is stored in an address different from that in the memory 26.

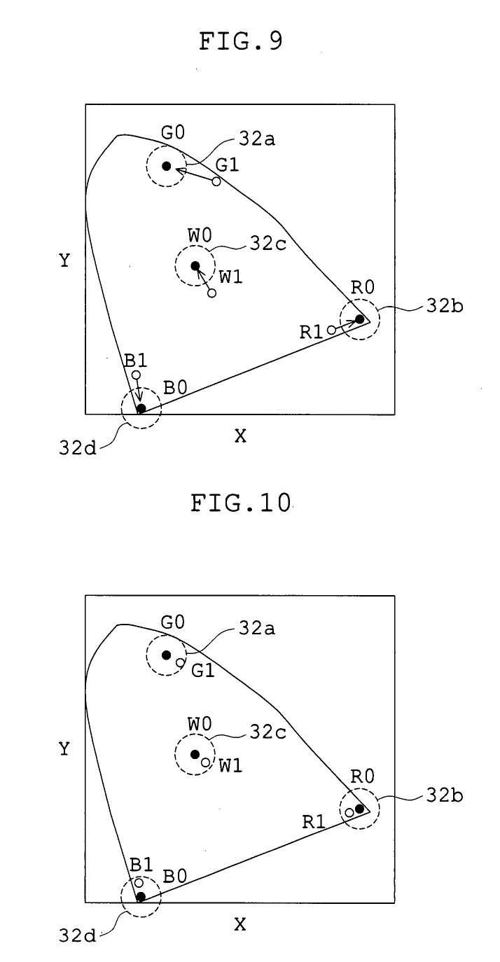

Next, the PC 8 plots the chromaticity value received on the chromaticity diagram 30 on the display screen of the display part 9, as shown in FIG. 9, and sets up it as position information (matrix parameter) on coordinates (Step S9). In an example shown in FIG. 9, as chromaticity coordinate by an image-for-calibration, W0, R0, G0, and B0 (reference position information), and as chromaticity coordinate by an image data having photographed the image-for-calibration, W1, R1, G1, and G1 (position information), difference of the coordinates of each color shows a deviation of color according to characteristics of the display apparatus, respectively. The chromaticity diagram 30 showing color information is displayed on a position which does not overlap with the guide domain 29. The operator displays a displayed calibration state (Step S10), confirms whether it is within a tolerance level defined beforehand or not, and then judges whether calibration is directed again or not (Step

If it is judged that it has not been completed by this judgment (YES), the operator operates the monitor setting buttons 31a, 31b, and 31c, respectively, looking at the chromaticity diagram 30, and changes suitably setting of the brightness of contrast, gamma, etc. of each color. If completion of calibration is directed, photographing is carried out again by returning to Step S4.

After repeating this operation two or more times, when it becomes to a state such that the chromaticity diagram 30 in FIG. 10 is shown, namely, a state such that coordinates difference between the chromaticity of the data of the image of photographed image-for-calibration W1, R1, G1, and G1, and the chromaticity of the image-for-calibration W0, R0, G0, and B0 becomes preferably in coincidence, or, when it becomes below a predetermined value of each color (when it enters in the adjustable ranges 32a, 32b, and 32c and 32d), the operator judges that calibration has been completed. When it is judged that it has been completed, and accordingly, re-photographing is not directed, after the output selection part 24 switches by the order of the CPU 5 so that an image from the signal process part 2 may be outputted to the controller 4, a series of processes is completed. Since a chromaticity coordinate plotted on the chromaticity diagram 30 (plotted value) is generated on the basis of a result of image picking up of one set of sample, even if the monitor setting buttons 31a, 31b, and 31c, are adjusted by operation, a plot value is not followed in real time. Therefore, repeating of image picking-up of samples is needed. Moreover, with respect to an amount of adjustment of any monitor setting buttons to be adjusted, there is no restriction at all. Therefore, a color reproduction performance can be grasped intuitively (through observation by eyes), and an adjustment result can be checked.

As explained above, according to the first embodiment, the operator of the image pick-up apparatus for microscopes uses the image pick-up apparatus as a calibration tool, and carries out adjustment of color-comparison much simpler by referring to the chromaticity information for calibration displayed on the display screen of the display part and the chromaticity information of the display part itself. Moreover, the operator can check timely state of color distribution of the current display part, and thus, return suitably a change of color characteristics owing to secular change to a normal state at the beginning, by carrying out periodically the calibration according to the present embodiment, not only at the time of replacing the display apparatus. Furthermore, the PC 8 can be constituted so that it may have an operation guiding function which displays a message for checking of start of calibration-operation, namely, a message based on a flow chart showing a calibration procedure on the display part 9 for giving a direction to the operator. By this operation guiding function, the operator may give a direction smoothly without making a mistake.

Next, modifications of the first embodiment mentioned above will be explained. In the first embodiment, the operator adjusts a monitor by using monitor setting buttons arranged in a lower part of a general-purpose display part. Contrary to this, in constitution such that the display part 9 is connected with via a device such as a video card equipped in the PC 8, it is also easily possible to change the setting mentioned above from the input device 7 of the PC 8, and to carry out comparison of color.

Furthermore, in the first embodiment, by displaying a state of a current chromaticity distribution on the display screen of the display part, the operator oneself checks by observation by one's eyes, and judges whether re-adjusting of color (hue) is necessary or not.

In this modification to that as mentioned above, difference of values of chromaticity coordinates (W1-W0, R1-R0, G1-G0, B1-B0) according to each color is computed in the CPU 5 or the PC 8, and on the basis of these values, distances between the chromaticity coordinates of the image-for-calibration and the chromaticity coordinates of a photographed image of the image-for-calibration is displayed on the display screen, and until all of the distances become within a predetermined value (adjustable ranges 32a, 32b, 32c, and 32d shown in FIGS. 9 and 10), and a message which directs re-adjustment to the operator is displayed on the display screen. By such way as mentioned above, monitor calibration work can also be made much smoothly.

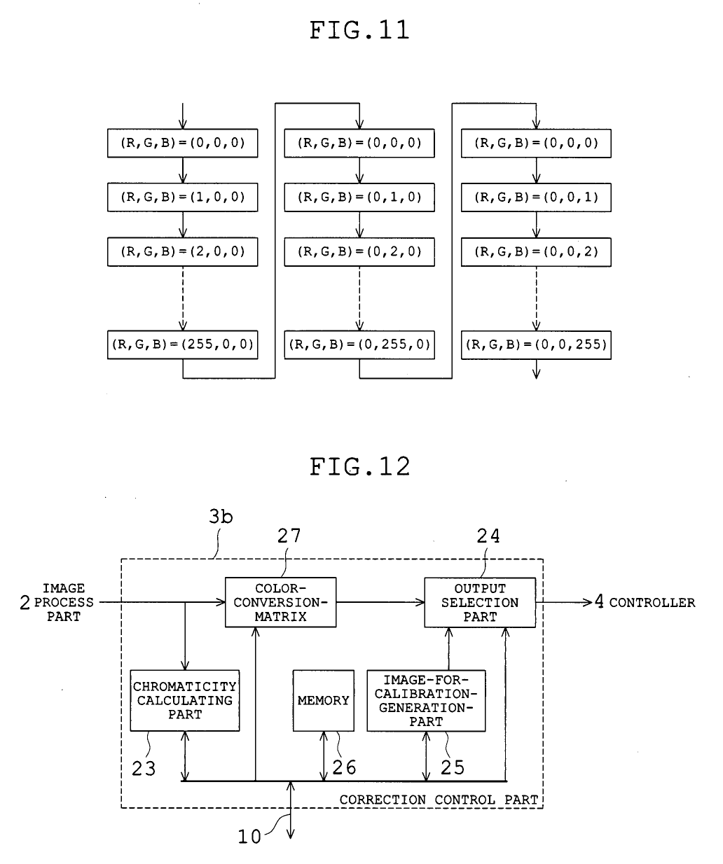

In the first embodiment, the chromaticity to an image having a predetermined RGB value for every color for calibration is computed. However, in spite of such fact as mentioned above, if for example, an image-for-calibration displayed on the display screen of the display part is scanned from 0 to the maximum (for example, 255) according to each color of RGB, and data of an image picked up is stored in a memory as shown in FIG. 11, gamma characteristics of the display part can be obtained.

According to the present embodiment as mentioned above, if photographing is carried out by generating images-for-calibration of various patterns in the CPU 5 or the PC 8,it is also possible to make a profile of the display part. In the present embodiment, an image-for-calibration is displayed in a predetermined domain of the display screen. However, if only when an image-for-calibration is photographed, the image-for-calibration is photographed in a state that it is displayed in full screen, an erroneous correction by deviation of position of a camera used can be prevented.

Next, an image pick-up apparatus for microscopes concerning the second embodiment of the present invention will be explained.

In the second embodiment, calibration of a display part is carried out by image process inside the image pick-up apparatus. In the present embodiment, only the correction control part 3b differs to constitution and arrangement shown in FIG. 1 of the first embodiment mentioned above, and the other constitution and arrangement are equivalent to the constitution and arrangement shown in FIG. 1. Accordingly, the same reference symbols are used and the explanation of the reference symbols will be omitted.

In the present embodiment, a color conversion matrix 27 is arranged at a correction control part 3b, wherein in stead of operation of monitor setting buttons of the display part 9, a displayed image is adjusted by setting of parameters of a color conversion matrix.

FIG. 12 is a diagram showing an inside constitution of the correction control part 3b in the present embodiment. In this constitution, an image data and synchronizing signal which the signal process part 2 outputs are inputted into the color conversion matrix 27 and the chromaticity calculating part 23. The color conversion matrix 27 performs a matrix operation of 3×3 shown in the following formula (1) to inputted RGB data, and outputs it to the output selection part 24. Here, although a coefficient aij (i, j=1, 2, 3) is set up by the CPU 5 through the control bus 10, it is possible for an operator to set up arbitrary values from the input device 7 by communication between the PC 8 and the CPU 5. The coefficient is set up in default; a11=a22=a33=1, and in the other case; 0 is set up. The CPU 5 stores the following two kinds of data in the memory 26 via the control bus 10.

$$( \begin{matrix}Rout \\ Gout \\ Bout\end{matrix} ) = ( \begin{matrix}a 11 & a 12 & a 13 & Rin \\ a 21 & a 22 & a 23 & Gin \\ a 31 & a 32 & a 33 & Bin\end{matrix} ) \qquad ( 1 )$$

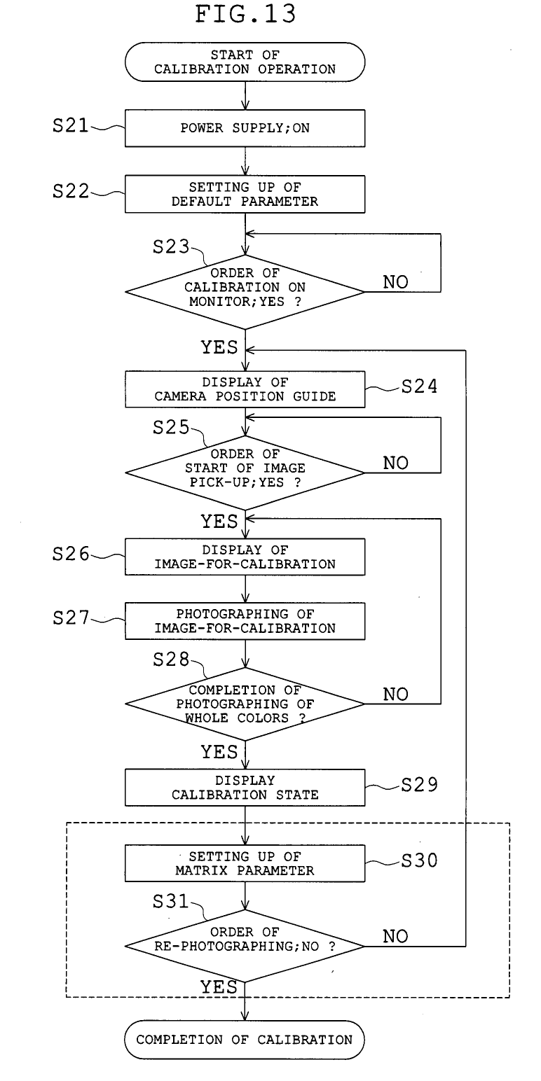

Referring to a flow chart shown in FIG. 13, operation of the image pick-up apparatus for microscopes of the present embodiment as mentioned above will be explained. In this sequence, explanation will be made simply since a series of steps (Steps: S21-S29) from a step in which the operator switches on power supply to a step in which the operator judges for directing start of photographing of an image-for-calibration are equivalent to the sequence (Steps S1-S9) of the first embodiment mentioned above.

First, the operator switches-on the power supply of the image pick-up apparatus for microscopes after setting the main body of the camera 13 directed toward the display screen of the display part 9. Then, the default parameter of each image process is setup. The guide domain 29 is displayed on the display screen by an order of start of calibration-operation, and the position of the main body of the camera 13 is adjusted so that it may be coincided with this guide domain 29. Then, the order is transmitted to the image-for-calibration-generation-part 25 by the order of calibration-photographing-start (Steps S21-S25).

Next, by the order from the CPU 5, the image-for-calibration-generation-part 25 generates a monochrome image data of brightness-value having (R, G, B)=(255, 0, 0), and outputs to the output selection part 24. The output selection part 24 outputs the monochrome image data to the controller 4 according to the order of the CPU 5. The image data which is outputted to the PC 8 via the I/F-part 6 from the controller 4 is displayed on the guide domain of the display screen in the display part 9 as shown in the first embodiment (Step S26).

Then, if the CPU 5 transmits the order for photographing to the drive part 33, the image of the display screen is photographed by the same procedure as shown in the first embodiment (Step S27). The data of photographed image is outputted to the correction control part 3 via the signal process part 2. At this time, an average value of brightness of frame (R1, G1, B1) computed by the chromaticity calculating part 23 and its chromaticity value are stored by the memory 26 through the control bus 10. Hereafter, in the same way, an image-for-calibration in which such as white, red, blue, green, etc. are set up beforehand is displayed on the display part 9, and then it is photographed by the image pick-up part 1, and then chromaticity value is calculated. The CPU 5 judges whether photographing has been completed or not, after calculating of the chromaticity value (Step 28). If it is judged that photographing has been carried out as to whole images-for-calibration set up beforehand (YES), in the same way as the first embodiment 1, the PC 8 displays each of transmitted images-for-calibration, and chromaticity-value data (X0, Y0) (X1, Y1) of the image in which the image-for-calibration has been picked up, by coordinates on the monitor (Step S29).

Here, the operator changes the parameter of a color conversion matrix from the input device 7 (Step S30), and judges whether the order of re-photographing has been transmitted to the PC 8 or not (Step S31). When there is the order of photographing (NO), it returns to Step S24, and displays the chromaticity of the image-for-calibration and of the photographed image of the image-for-calibration through the same sequence, by coordinates on the monitor.

Here, when the chromaticity difference between the image-for-calibration and the photographed image of the image-for-calibration is brought within a predetermined scope as shown in FIG. 10, the operator finishes calibration without changing the parameter of the color conversion matrix and giving the order of re-photographing. When the chromaticity difference is beyond the predetermined scope, the operator repeats works from Step S24 to Step S31 until the chromaticity difference falls within the predetermined scope while adjusting the parameter of the color conversion matrix.

As mentioned above, since the display apparatus is calibrated by the color conversion matrix 27 built in the imaging apparatus, it becomes possible to carry out the calibration easily, even if the display apparatus which the operator uses does not have sufficient adjusting function.

Furthermore, when a coefficient of the color conversion matrix is computed to the image-for-calibration of four or more colors, what is necessary is to extend the matrix of the formula (1) in the direction of column.

Since a chromaticity coordinate (plotted value) plotted on the chromaticity diagram 30 is based on the coefficient of the color conversion matrix, the plotted value is not followed in real time. Accordingly, coefficient calculation of the color conversion matrix is often needed. As to how many coefficients of a color conversion matrix should be adjusted, there is no restriction at all. Therefore, a color reproduction performance can be grasped intuitively (by observation-by-eyes), and result of adjustment can be checked.

According to the present embodiment as mentioned above, even if a sufficient adjustment mechanism in the display apparatus is not arranged, by changing the coefficient of the color conversion matrix by using software of the PC 8, adjustment can be carried out. At this time, if the image pick-up image data which has not been corrected, and the corrected image are stored as other different file, by correcting again the image data which has not been corrected when reading the image on the other display apparatus, calibration for obtaining an appropriate color display is possible.

Next, the third embodiment according to the present invention will be explained.

In the third embodiment, a value of contrast is computed from the image pick-up data of a monochrome image displayed on the display screen of the display apparatus, and a state of arrangement of the camera for an image picking-up is judged. As for arrangement or constitution of the present embodiment, it is equivalent to constitution and the arrangement of the first embodiment mentioned above, and accordingly detailed explanation will be omitted by using the same reference symbols.

The present embodiment differs only in aspect of operation to the first embodiment.

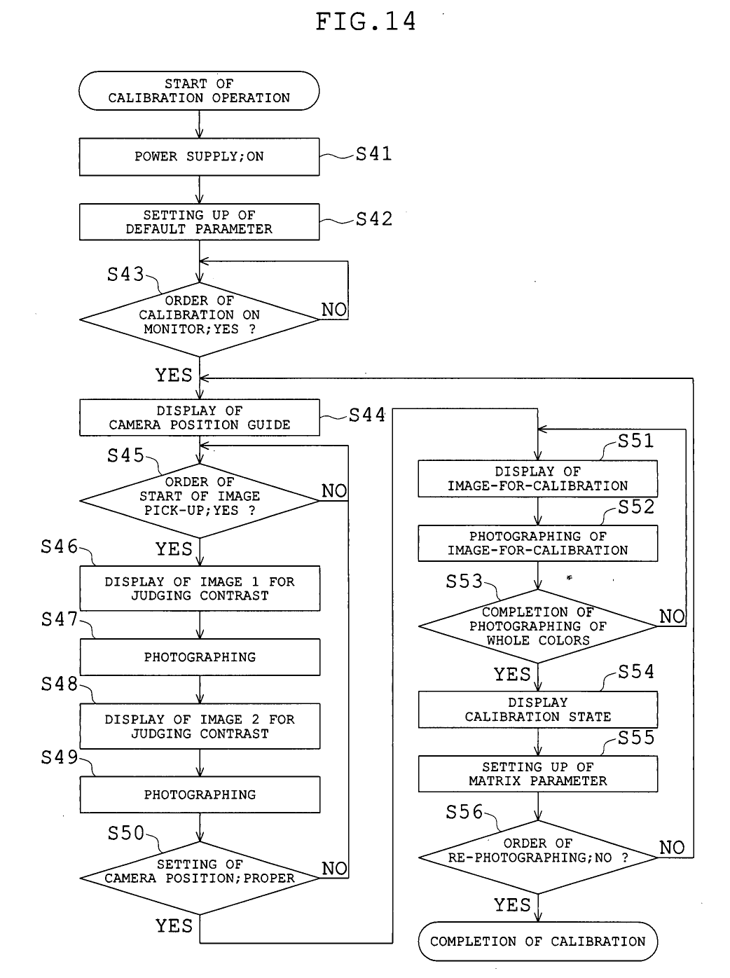

Referring to a flow chart shown in FIG. 14, operation of the present embodiment above will be explained.

Explanation will be made simply, since in this sequence, a series of steps (Steps S41-S45) that is, from a step in which the operator switches-on the power supply to a step in which the operator judges and directs start of photographing of an image-for-calibration is equivalent to the sequence (Steps S1-S5) of the first embodiment mentioned above. First, the operator switches on the power source of the image pick-up apparatus for microscopes after setting the main body of the camera 13 directed toward the display screen of the display part 9. Then, the default parameter of each image process is setup. The guide domain 29 is displayed on the display screen by an order of start of calibration-operation, and the position of the main body of the camera 13 is adjusted so that it may be coincided with this guide domain 29. Then, by using an order of start of photographing for calibration, the order is transmitted to the correction-image-generation part 25 (Steps; S41-S45).

Next, the CPU 5 which received the order of the start of-photographing made by the operator from the input device 7 via the PC 8 transmits the order to the correction-image-generation part 25, wherein it transmits white image data of brightness-value (R, G, B)=(255, 255, 255) to the controller 4. If the controller 4 transmits the image data which received through the I/F part 6 to the PC 8, it displays this input image as an image 1 for judging of contrast within the guide domain 29 (Step; S46).

Then, the image 1 for judging of contrast is photographed (Step S47). By this photographing, according to the order signal by the CPU 5, the drive part 33 drives the image pick-up element 15, and an incident light image of the contrast judging image 1 which is formed by the image pick-up lens 14 is photo-electrically converted, and an image signal is generated, Furthermore, in the CDS/AGC part 16 and the A/D conversion part 17, at later stages, a predetermined image process is performed, and A/D conversion process is carried out, and then it is generated as digitized image data. The data of photographed image is outputted to the correction control part 3 via the signal process part 2. Next, the chromaticity calculating part 23 in the correction control part 3 computes an average value of brightness per one frame (the average value is denoted by Kw) of whole colors of RGB color based on the image data, and the value is stored in the memory 26 through the control bus 10.

Next, the correction-image-generation-part 25 outputs black-color-image data of brightness-value (R, G, B)=(0, 0, 0) to the output selection part 24, when it receives a signal of the order to display from the CPU 5. The image data inputted into the output selection part 24 is displayed within the guide domain 29 of the display part 9 through the same course as mentioned above (Step S48). Then, when the CPU 5 transmits a driving signal to the drive part 33 by the same process as mentioned above, an average value of brightness of one frame (the average value is denoted by Kb) of the whole RGB color of an image picked-up is stored in the memory 26 (Step; S49).

Then, the CPU 5 reads values of Kw and Kb from the memory 26, and a contrast ratio (Co=Kw/Kb), namely, a ratio of the average value of brightness (the ratio is denoted by Co) is computed. Then, by this average value ratio of brightness (Co), judgment is made as to whether a state of arrangement of the camera is suitable or not (Step; S50).

Concretely, when by comparing the average value ratio of brightness (Co) with the predetermined brightness value (Cok) defined before and, the ratio of the average value of brightness (Co) is less than a predetermined brightness value (Cok), (in this case; NO), it is judged that it is inappropriate, as it is not arranged so that it may become perpendicular to the display screen, and the PC 8 displays on the display part 9 a message for the order of re-arrangement of the camera.

The operator observes this display, and returns to the step S45, wherein the camera is arranged again, and then the operator directs the order of start of re-photographing from the input device, and carries out photographing and judging similarly.

On the other hand, when it is judged that the ratio of the average value of brightness (Co) is more than a predetermined brightness value (Cok),(in this case; YES), the CPU 5 carries out the process of photographing for calibration after Step S51. Processes from the following Step 51 to Step 55 by which the sequence ends will be explained briefly, since the processes are equivalent to the processes from Step S6 to Step S11 in the first embodiment mentioned above.

Next, the image data from the main part of the camera 13 is displayed on the guide domain 29 as it is, and is photographed. Image process such as digitalization, etc., is carried out to the photographed image data. Matrix operation of this image data is carried out by the chromaticity calculating part 23, and its chromaticity value is computed and stored in the memory 26. After this, by the image-for-calibration-generation-part 25, an image-for calibration in which such as white, red, blue, green, etc. are set up beforehand is displayed on the display part 9, and is photographed by the image pick-up part 1, and then the chromaticity value is calculated. When such photographing is completed, the chromaticity values of each image-for-calibration and the image of which the said each image has been photographed, and which have been stored in the memory 26 are displayed as a chromaticity diagram 30 on the display screen. At the same time, a coefficient of the color conversion matrix is set up. As mentioned above, when a displayed state of display of calibration is confirmed, and it becomes below a predetermined value of each color (when it enters in the adjustable ranges 32a, 32b, 32c, and 32d). If the operator judges that calibration has been completed, a series of processes are completed (Step; S51-S56).

As explained above, according to the present embodiment, when the ratio of average values of brightness (Co) by monochrome photographed image for obtaining contrast ratio is less than a predetermined brightness value (Cok), namely, when the contrast ratio is small, it is judged that a photographing optical axis of the main body of the camera arranged for photographing for calibration is mounted with an inclined angle, but not perpendicular to the display surface of the display part 9. Until such inappropriate arrangement is improved, and the display screen and the optical axis of the camera becomes perpendicular or becomes within tolerance level, the operator repeats arranging the main body of camera 13.

Next, the forth embodiment according to the present invention will be explained.

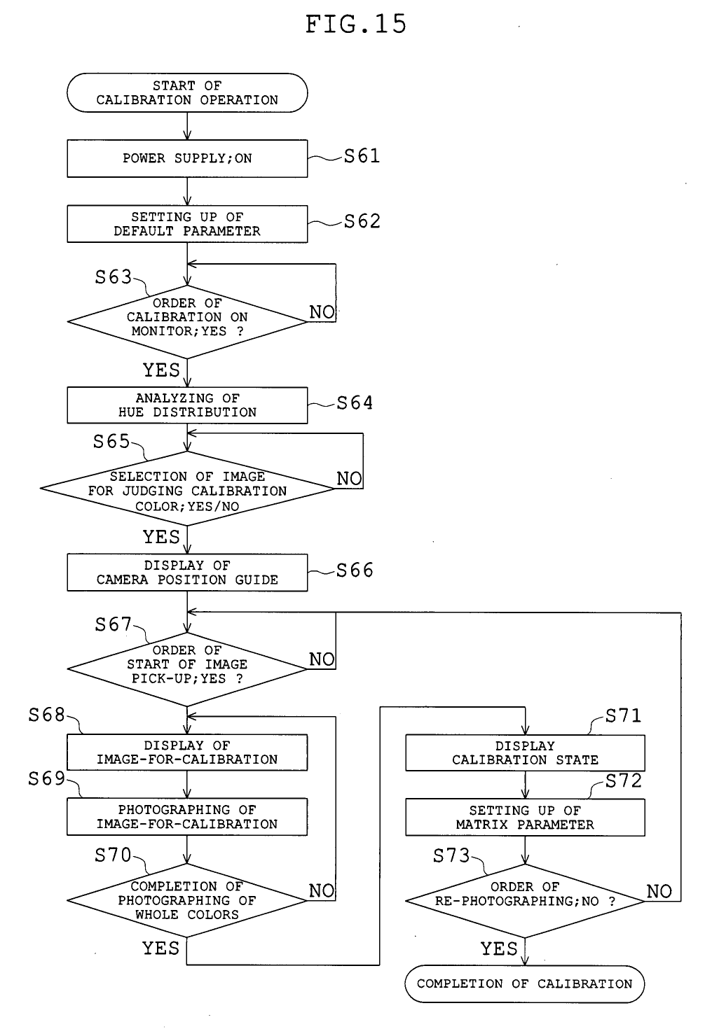

According to the present embodiment, color which appears in an image of specimen as a feature is detected, and on the basis of the color, color correction of the display apparatus is carried out. By specifying one of the image data that have been observed by a microscope and recorded beforehand, hue information is analyzed from the color difference information on the image data. Sample color to be calibrated is determined on the basis of this hue information. The most appropriate color for an image which is actually observed is displayed on the monitor, and color adjustment of a monitor image is carried out on the basis of this. By such way mentioned above, the most appropriate color-calibration is carried out. As for arrangement or constitution of the present embodiment, it is equivalent to the constitution and arrangement of the first embodiment mentioned above, accordingly detailed explanation will be omitted by using the same referential symbols. The present embodiment differs only in aspect of operation to the first embodiment. Referring to the flow chart shown in FIG. 15, the operation of the present embodiment above will be explained.

First, an operator installs the main body of camera 13 of the image pick-up apparatus for microscopes to the display surface of the display part 9 installed on a base plate. After such setting as mentioned above, a power supply of the image pick-up apparatus for microscopes is switched-on by the operator (Step S61). The default parameter of each image process is set for each part of apparatus by supplying power (Step S62).

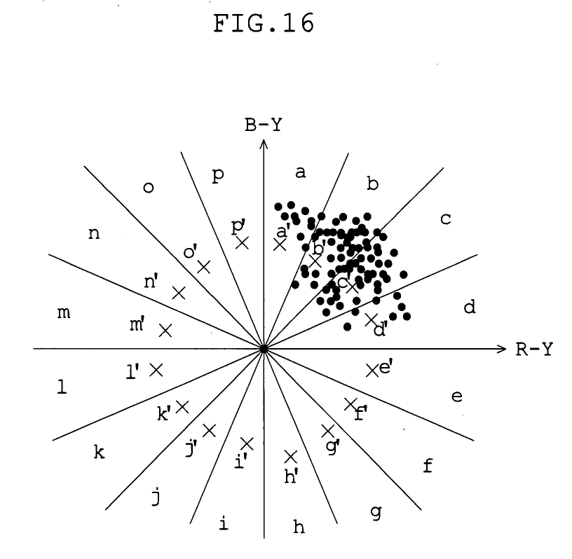

Next, the PC 8 used as a color information extraction means displays on the screen of the display part 9, a message that specifies a data file of the observed image which has been photographed beforehand by the operator, and it is judged whether an image for judging of color for calibration is specified or not (Step S63). It stands by until the image becomes specified (NO). If a file of the observed image stored in a storage apparatus (not shown) in the PC 8 is specified from the input device 7 (YES), the PC 8 obtains a color-difference signal for every pixel of specified image data. After this, when hue angle is divided into sixteen domains from a to p as shown in FIG. 16, the PC 8 analyzes in which domain hue of each pixel of the observed image data specified is contained (Step S64).

On the basis of this analysis, judgment is made as to a preferable color to which correction is to be carried out (Step S65).

In this judgment, the PC 8 transmits data of RGB-brightness-value having each hue at representative points a′, b′, c′ and d′ in each domain, where the hue of each pixel of data of specified, observed image is contained in the domain of a, b, c, and d in FIG. 16, namely, (Ra′, Ga′, Ba′), (Rb′, Gb′, Bb′), (Rc′, Gc′, Bc′), and (Rd′, Gd′, Bd′) to the CPU 5 via the I/F part 6 and the controller 4. The CPU 5 stores these values in the memory 26.

Next, after displaying a guide of the camera position (Step S66), judgment is made as to whether there is an order for start of calibration of the display apparatus or not (Step; S67). In this judgment, when the operator inputs the order for start of calibration using the input device 7 (YES), the PC 8 displays on the display screen a guide domain in which the operator sets a position of the main body of camera. When the operator finishes to set the camera, a message of such setting is given from the input device 7.

When the CPU 5 reads out the predetermined RGB-value (Ra′, Ga′, Ba′) data saved in the memory 26, and an order is transmitted to the image-for-calibration-generation-part 25, the part 25 generates an image data having this RGB brightness value, and outputs it to the output selection part 24. Then, an image-for-calibration based on this image data is displayed on the display screen (Step S68). A chromaticity value is computed by photographing the displayed image-for-calibration, and it is stored in the memory 26. Then, by the same way as mentioned above, as for other three colors such as (Rb′, Gb′, Bb′), (Rc′, Gc′, Bc′), and (Rd′, Gd′, Bd′), a state of calibration is displayed on the display screen, and photographing of the state is carried out, and each chromaticity value is computed respectively, and then it is stored in the memory 26 (Step S69).

Next, the CPU 5 judges whether photographing images of all colors have been completed or not (Step S70). When it is judged that photographing images of all colors have been completed, the chromaticity value stored in the memory 26 is read out, and it is transmitted to the PC 8. The PC 8 displays on the display screen a received chromaticity value of each color and the image-for-calibration in the same manner as shown in FIG. 9 (Step; S71). When the coefficient of a color conversion matrix is set up as mentioned above (Step S72), a displayed state of display of calibration is confirmed. Then, if the operator judges that re-photographing in not necessary, a series of processes is ended (Step; S73).

According to the fourth embodiment as mentioned above, since an observed image data is analyzed, and comparison of color of the display apparatus is carried out to the color which appears as a feature of the image, more appropriate color correction can be realized according to the operator's object of observation.

In the present embodiment, when color having feature of an observed image is extracted from hue distribution, by setting a minimum number of the pixel distributed over each hue domain, and the like, or by filtering the pixel for selection by defining an upper and lower limit value of brightness value, even if noise components such as a dust, a defected pixel, etc. are contained in the image data these can be removed, and accordingly erroneous judgment of hue can be prevented. Moreover, to picture signal displayed on the display pixel of a liquid crystal display (LCD panel etc.), by setting an arbitrary thresholds experientially calculated by experiment etc., and by regarding the image signal below a certain threshold as a noise signal, a pixel for extracting color information can be selected according to the threshold. Moreover, since color for correction can be changed according to the color distribution of a specimen, calibration of color can be carried out by the specimen much appropriately.

The present invention has the following functions and effects by the constitution mentioned above.

The image pick-up apparatus for microscopes according to the present invention comprises a display means to display an image of a sample, a calibration-image-generation-means to generate an image-for-calibration which is displayed on the display means, an image pick-up means which photographs the image-for-calibration, and a color information display means which displays color information of an image-for-calibration generated by the calibration-image-generation means and a photographed image-for-calibration photographed by the image pick-up means the color information of the image-for-calibration and the photographed image-for-calibration is simultaneously displayed on the screen of the display apparatus. Thus, efficiency of calibration working by an operator is improved.

In the image pick-up apparatus for microscopes according to the present invention, as for data of the photographed image-for-calibration photographed by the image pick-up means and data of the image-for-calibration which is generated by the image-for-calibration-generation-means, the color on the display means is corrected. Therefore, even though regulating function of a monitor is insufficient or improper, comparison of color of the image-for-calibration and the photographed image-for-calibration can be carried out without using the regulating function of the monitor.

In the image pick-up apparatus for microscopes according to the present invention, since it has an arrangement-state-prediction means which predicts an arrangement relation between an image pick-up means and an display means, the operator can know whether a state of arrangement of the image pick-up means and the display apparatus are good or not when the image-for-image-for-calibration is picked-up.

In the image pick-up apparatus for microscopes according to the present invention, by using the arrangement-state-prediction means, a contrast ratio is computed from the image data photographed by the image pick-up means displayed on the display means, and an angle between a direction of an optical axis of the image pick-up apparatus for photographing the image-for-calibration and a surface of the display screen of the display apparatus can be predicted on the basis of the contrast ratio.

The image pick-up apparatus for microscopes according to the present invention comprises a color-information-extraction-means which extracts color information contained in an image specified by the operator, wherein an image having information of color extracted by the color-information-extraction-means is displayed on the display means as the image-for-calibration.

In the image pick-up apparatus for microscopes according to the present invention, the image-for-calibration and a color-component display are displayed on different domain on the display means, and working efficiency of calibration by the operator can be raised.

In the image pick-up apparatus for microscopes according to the present invention, since the display means displays an amount of difference of color information (or color component) between data of the image-for-calibration which is generated by the image-for-calibration-generation-means, and data of the photographed image-for-calibration photographed by the image pick-up means, the operator can know a state of calibration on the display screen.

In the image pick-up apparatus for microscopes according to the present invention, two or more images are generated in the image-for-calibration-generation-part, and characteristics of the display means are detected on the basis of data of the image pick-up image in which said two or more images is photographed by the image pick-up means. Therefore, a monitor profile can be generated simply, without using special calibrator.

In the image pick-up apparatus for microscopes according to the present invention, two or more images having different brightness values of the same color are generated in the image-for-calibration-generation-means, and gamma characteristics of the display means can be computed based on an image in which two or more images displayed on the display means is photographed by the image pick-up means.

According to the image pick-up apparatus for microscopes of the present invention, since a pixel for extracting color information is selected according to a predetermined threshold in the color information extraction means, the pixel which may generate a noise and defected pixel can be removed.

According to the image pick-up apparatus for microscopes of the present invention, since a message showing a calibration procedure is displayed on the display means, the operator can carries out a calibration operation smoothly.

The present invention is not limited to each embodiment described above, and includes any modification of it within a scope which does not deviate from the spirits of the present invention.

What is claimed is:

1. An image pick-up apparatus for microscopes comprising a display means which displays an image, an image-for-calibration-generation-means to generate a predetermined image-for-calibration which is displayed on the display means, and an image pick-up means which photographs the image-for-calibration displayed on a display screen of the display means, wherein standard color information as a criterion of color of the image-for-calibration generated by the image-for-calibration-generation-means, and color information in the image-for-calibration photographed by the image pick-up means, is displayed on the display screen of the display means.

2. The image pick-up apparatus for microscopes according to the claim 1 comprising an operation-process-means in which the color information in the image-for-calibration photographed by the image pick-up means and the standard color information of the image-for-calibration which generated by the image-for-calibration -generation-means are displayed on coordinates of color coordinates displayed on the display means, and the standard color information of the image-for-calibration generated by the image-for-calibration-generation-means and the color information of the image-for-calibration photographed by the image pick-up means are made coincided.

3. The image pick-up apparatus for microscopes according to the claim 1, comprising a color-correction-means arranged at the display means, in which color correction which changes a color correction condition to the an image displayed on the display screen, and
an operation-process-means in which color information of the image-for-calibration photographed by the image pick-up means, and the standard color information of the image-for-calibration generated by the image-for-calibration-generation-means are displayed on the coordinates of color coordinates displayed on the display means, and the displayed color by the display means is corrected so that the standard color information of the image-for-calibration generated by the image-for-calibration generation means and the color information of the image-for-calibration photographed by the image pick-up means may be coincided, wherein when a coincidence process of the standard color information of the image-for-calibration and the color information of the image-for-calibration by the color-correction-means exceeds a color correction range of the color correction means, the coincidence process by an operation-process-control-means is performed.

4. The image pick-up apparatus for microscopes according to the claim 1, further comprising an arrangement-state-judging-means which judges a state of arrangement of the image pick-up means and the display means, wherein judgment result by the arrangement-state-judging-means is displayed on the display means.

5. The image pick-up apparatus for microscopes according to the claim 4, wherein the arrangement-state-judging-means computes contrast from data of a photographed image in which the image displayed on the display means has been photographed by the image pick-up means, and judges the state of arrangement by comparing the contrast with a predetermined threshold.

6. The image pick-up apparatus for microscopes according to the claim 1, comprising a color-distribution-information-extraction-means which extracts information of color distribution including a state of the color in each pixel contained in an image specified by an operator, wherein the image having the information of color distribution extracted by the color-distribution-information-extraction-means is displayed on the display means as the image-for-calibration.

7. The image pick-up apparatus for microscopes according to the claim 1, wherein the image-for-calibration and the color information are displayed on different domains on the display screen of the display means.

8. The image pick-up apparatus for microscopes according to the claim 1, wherein the display means displays an amount of difference of color information between color information of the image-for-calibration generated by the image-for-calibration-generation-means and the color information of a photographed image-for-calibration which has been photographed by the image pick-up means.

9. The image pick-up apparatus for microscopes according to the claim 1, comprising monitor-characteristics-detection-means which generates two or more images in the image-for-calibration-generation-part, and detects characteristics of the display means based on image data of two or more images photographed by the image pick-up means.

10. The image pick-up apparatus for microscopes according to the claim 9, wherein the monitor-characteristics-detection-means generates two or more images having the same color but a different brightness value in the image-for-calibration-generation-means, and computes gamma characteristics of the display means on the basis of the image data of two or more images displayed on the display means which has been photographed by the image pick-up means.

11. The image pick-up apparatus for microscopes according to the claim 6, wherein the color-distribution-information-extraction-means selects a pixel which extracts color information according to a threshold set up arbitrarily.

12. The image pick-up apparatus for microscopes according to the claim 2, wherein the operation-process-controlling-means has a message function which directs a calibration procedure on the screen of the display means.

13. The image pick-up apparatus for microscopes according to the claim 2, wherein the operation-process-means has a color-conversion-matrix-changing-means which corrects the displayed color on the basis of the color information of the image-for-calibration and the color information of the photographed image-for-calibration.

14. The image pick-up apparatus for microscopes according to the claim 3 wherein the operation-process-means has a color-conversion-matrix-changing-means which corrects the displayed color on the basis of the color information of the image-for-calibration and the color information of the photographed image-for-calibration.

15. An image pick-up apparatus for microscopes comprising an image pick-up means, a recording means which records an image which has been picked up, a display means which displays the image, an image-for-calibration-generation-means in which characteristics of the image in the image generates an image-for-calibration which has been known, and
a control means in which the image-for-calibration of the image-for-calibration-generation-means is displayed on the display means, and
the data of the image-for-calibration picked up by the image pick-up means is recorded, and image-characteristics of recorded data of the image-for-calibration is analyzed, and
the analyzed image-characteristics and the image-characteristics of the image-for-calibration are displayed on the display means.

16. An adjusting method of an image which is applied to an image- pick-up apparatus-for-microscopes having an image pick-up means, a recording means which records an image picked up, a display means which displays the image, and an image-for-calibration-generation-means in which image-characteristics in the image generates a known image-for-calibration, comprising the following steps;
a step which outputs the image-for-calibration from the image-for-calibration-generation-means, and displays the image-for-calibration on the display means;
a step which picks up the image-for-calibration displayed on the display means by the image pick-up means, and records data of the image which has been picked up for calibration; and
a step which analyzes characteristics of an image of the recorded data of the image-for-calibration, and displays analyzed characteristics of an image and characteristics of an image of the image-for-calibration on the display means.
